(19) United States
(12) Patent Application Publication
(10) Pub. No.: US 2025/0012701 A1
(43) Pub. Date: Jan. 9, 2025

(54) SENSOR ARRANGEMENT

(71) Applicant: Endress+Hauser SE+Co. KG, Maulburg (DE)

(72) Inventor: Raphael Kuhnen, Schliengen (DE)

(21) Appl. No.: 18/713,405

(22) PCT Filed: Nov. 21, 2022
(86) PCT No.: PCT/EP2022/082660

§ 371 Date: May 24, 2024

(30) Foreign Application Priority Data
Dec. 9, 2021 (DE) 10 2021 132 527.7

(51) Int. Cl. G01N 15/08; G01F 23/284

(52) U.S. Cl. CPC G01N 15/0806; G01F 23/284

(57) ABSTRACT

A sensor arrangement for determining and/or monitoring at least one process variable of a medium in a containment comprises a magnet arrangement having at least one permanent magnet and/or at least one coil for producing at least one magnetic field wherein the magnet arrangement is arranged and/or embodied in such a manner that the magnetic field penetrates, at least partially, through the medium in the containment and is influenced by at least one property of the medium; at least one magnetic field sensor for detecting the magnetic field; and an electronics for determining and/or monitoring the at least one process variable and/or characteristic variable based on the magnetic field. According to the invention, the magnet arrangement and the magnetic field sensor are arranged outside of the containment and secured on a wall of the containment.

The invention relates to a sensor arrangement for determining and/or monitoring at least one process variable and/or characteristic variable of a medium in a containment, comprising a magnet arrangement, a magnetic field sensor and an electronics.

Field devices for monitoring and/or determining at least one, for example chemical or physical, process variable of a medium are known in a wide variety of embodiments in the state of the art. In the context of the invention, in principle, all measuring devices and sensor arrangements are referred to as field devices, when they are applied near to a process and deliver or process process-relevant information, thus, also remote I/Os, radio adapters, and, generally, electronic components, which are arranged at the field level. A large number of such field devices are manufactured and sold by the Endress+Hauser group of companies.

Many measuring principles underpinning various field devices known in the state of the art permit a characterizing of a medium based on and/or regarding its magnetic and/or electrical properties. In this connection, used are both invasive measuring devices, in the case of which the sensor unit is introduced in direct contact with the medium, and also non-invasive measuring devices, in the case of which the process variable of the medium is registered outside of the container, in which the medium is located. Non-invasive measuring devices offer basically the advantage that no engagement in the process is necessary. However, until now, such measuring devices have been only limitedly available, since as regards the attainable accuracy of measurement and as regards possible disturbing influences, for example, from the container wall or the environment, many different factors have to be taken into consideration. Nevertheless, a general trend is to try to have the measuring device penetrate into the process as little as possible.

In the case of media characterizing based on or with the help of magnetic fields, there is in the case of non-invasive measuring devices the difficulty that walls of the containment can significantly impede, for example, corrupt, the measurement.

Starting therefrom, an object of the invention is to provide a non-invasive sensor for characterizing media, especially in industrial process automation, by means of which sensor reliable and exact measurements are possible.

The object is achieved by a sensor arrangement for determining and/or monitoring at least one process variable and/or characteristic variable of a medium in a containment, comprising
a magnet arrangement having at least one permanent magnet and/or at least one coil for producing at least one magnetic field, which magnet arrangement is arranged and/or embodied in such a manner that the magnetic field penetrates, at least partially, through the medium in the containment and is influenced by at least one property of the medium,
at least one magnetic field sensor for detecting the magnetic field, and
an electronics for determining and/or monitoring the at least one process variable and/or characteristic variable based on the magnetic field.

According to the invention, the magnet arrangement and the magnetic field sensor are arranged outside of the containment and secured on a wall of the containment. Also the electronics can be secured externally at the containment, and/or arranged together with the magnet arrangement and the magnetic field sensor. It can, however, also be arranged separately from these components.

In the case of such a non-invasive sensor arrangement, an interaction with the medium occurs by means of the magnetic field produced by the magnet arrangement, which magnetic field penetrates, at least partially, through the wall of the containment and the medium. The magnetic field is influenced by at least one property of the medium, such that the at least one process variable and/or characteristic variable is ascertainable based on the magnetic field.

The containment is, for example, a container or a pipeline. It can likewise be a single use container. In the case, in which the magnet arrangement includes at least one coil, the coil can, additionally, also have a coil core, especially a material having a high permeability. It is in the case of use of a coil, on the one hand, possible to produce a magnetic field, which is essentially constant with time. It is, however, likewise possible to modulate the magnetic field, especially as regards frequency and/or amplitude.

In an embodiment, the magnet arrangement, especially the permanent magnet and/or the coil, is arranged and/or embodied in such a manner that in a predeterminable region, especially outside of the containment, a field strength of the magnetic field is minimum. The magnetic field strength has in the predeterminable region, thus, an, especially local, minimum. In the predeterminable region, accordingly only small background fields are present, such that a media induced change of the magnetic field in the predeterminable region is especially easily and effectively registrable.

In an additional embodiment, the magnet arrangement comprises at least one permanent magnet, wherein the at least one permanent magnet of the magnet arrangement is magnetized in parallel with the wall of the containment. In this way, it is possible, in simple manner, to achieve an effective penetration of the medium by the magnetic field produced by means of the permanent magnet. In the case of use of a coil, such can be arranged and/or embodied in such a manner that a corresponding magnetic field is producible.

Preferably in the case, in which the magnet arrangement comprises at least one permanent magnet, the at least one permanent magnet of the magnet arrangement is a ring magnet or a rod magnet. In the case of application of at least one coil, the coil can be analogously embodied.

The application of permanent magnets for the magnet arrangement is especially advantageous relative to the energy requirement of the sensor arrangement.

An embodiment of the sensor arrangement of the invention includes that the magnet arrangement comprises at least two permanent magnets and/or coils for producing at least two magnetic fields, wherein the magnet arrangement is arranged and/or embodied in such a manner that the magnetic fields penetrate, at least partially, through the medium in the containment and are influenced by at least one property of the medium. By use of at least two permanent magnets and/or coils, the process variable and/or characteristic variable of the medium can be differentially registered, which, in turn, produces an increased accuracy of measurement.

It is also an option to use at least one permanent magnet and at least one coil.

Advantageously, the at least two permanent magnets and/or coils are arranged adjoining one another. Preferably, the two permanent magnets and/or coils have a predeterminable separation from one another.

It is, additionally, advantageous that the at least two permanent magnets and/or coils are arranged and/or embodied in such a manner that they are oppositely polarized. In the case of more than two permanent magnets and/or coils, advantageously, adjoining permanent magnet and/or coils are oppositely polarized.

It is, finally, likewise advantageous that the sensor arrangement includes, additionally, at least two magnetic field sensors, wherein each magnetic field sensor is arranged in such a manner that it can register one of the at least two magnetic fields, and wherein the electronics is especially embodied to ascertain the at least one process variable and/or characteristic variable of the medium based on the at least two magnetic fields.

In an embodiment, the magnetic field sensor is a flux gate sensor, a magnetostrictive sensor, especially a GMR-, AMR- or TMR sensor, a sensor comprising a mechanically oscillatable, magnetoelectric sensor element, or a quantum sensor, especially a gas cell or a sensor having a sensor element having a crystal body and at least one defect.

In the case, in which a sensor comprising a mechanically oscillatable, magnetoelectric sensor element is used, it is preferably a sensor element, which has at least a first layer of a magnetostrictive material, a second layer of a piezoelectric material, and at least one electrode of an electrically conductive material, especially metal. The sensor, especially an electronics, is, additionally, embodied to excite the sensor element by means of an excitation signal, such that mechanical oscillations are executed, and to receive the mechanical oscillations of the sensor element and to convert such into a received signal, to produce the excitation signal starting from the received signal, and based on the received signal to ascertain a variable linked with the magnetic field. Based on such variable, then the process variable and/or characteristic variable of the medium can be ascertained. In this connection, comprehensive reference is taken to German patent application No. 102021109408.9 unpublished as of the earliest filing date of this application.

In the case of a quantum sensor, in contrast, it is utilized that certain quantum states of individual atoms or arrangements of atoms can be very exactly controlled and read-out. In this way, for example, precise and low-disturbance measurements of magnetic fields are possible. In this connection, different spin based sensor arrangements are known, in the case of which atomic transitions in crystal bodies are applied for detecting changes of magnetic fields. Known, moreover, are also various systems based on quantum optical effects, such as, for example, quantum gravimeters, NMR gyroscopes and optically pumped magnetometers. Especially the latter operate based on, among other things, gas cells.

In the case of a quantum sensor in the form of a gas cell, atomic transitions as well as spin states, among others, are optically detected for determining magnetic and/electrical properties. A gas cell typically includes a gaseous alkali metal as well as a buffer gas. Magnetic properties of a medium surrounding the gas cell can be determined by means of Rydberg states produced in the gas cell. In the case of sensors comprising at least one crystal body having at least one defect, such is a spin based quantum sensor, in the case of which atomic transitions in different crystal bodies are utilized, in order to detect even small changes of magnetic fields. Typically used as crystal body is diamond having at least one silicon- or nitrogen defect, silicon carbide having at least one silicon defect or hexagonal boron nitride having at least one defect-color center. The crystal body can basically have one or more defects. In the case of a plurality of defects, a linear arrangement of the defects is preferable.

In this connection, known from DE 3742878 A1 is, for example, an optical magnetic field sensor, in the case of which a crystal is used as magnetically sensitive optical component. Other sensors using defects in crystal bodies are described in DE 10 2017 205 099 A1, DE 10 2017 205 265 A1, DE 10 2014 219 550 A1, DE 10 2018 214 617 A1, DE 10 2016 210 259 A1 and German patent applications 10 2020 123 993.9, 10 2021 100223.0 and 102021113199.5 unpublished as of the earliest filing date of this application. Comprehensive reference is likewise taken to these documents.

In an embodiment of the sensor arrangement, the magnetic field sensor is arranged in a predeterminable region outside of the containment, where a field strength of the magnetic field is minimum. Preferably, the magnet arrangement, especially the at least one permanent magnet and/or the at least one coil, is then correspondingly arranged and/or embodied. Using such an arrangement and/or embodiment, negative effects due to a possible saturation of the magnetic field sensor can be prevented and media induced changes of the magnetic field, and the variable related with the magnetic field, can be precisely and exactly registered.

It is, however, likewise advantageous that the magnetic field sensor is arranged in such a manner that it is oriented perpendicularly to a tangent of a field line of the magnetic field. Also, by such an embodiment and/or arrangement of the magnetic field sensor and/or a corresponding arrangement and/or embodiment of the magnet arrangement, a variable related with media induced changes of the magnetic field, and with the magnetic field, can be especially precisely and exactly registered.

In a preferred embodiment, the magnet arrangement comprises at least one permanent magnet in the form of a ring magnet or a coil secured in such a manner on the wall of the containment that a rotation axis of the ring magnet or the ring coil is oriented perpendicularly to the wall of the containment, and wherein the magnetic field sensor is arranged in a region around a midpoint of the ring magnet or the ring coil. In the midpoint, or in a predeterminable region surrounding the midpoint of the ring magnet, or the ring coil, the magnetic field strength is minimum. The magnetic field sensor is arranged in this predeterminable region.

In an additional preferred embodiment, the magnet arrangement comprises at least three adjoining permanent magnets, especially in the form of rod magnets, or coils, which are magnetized and arranged, in each case, in parallel with the wall of the containment, wherein adjoining rod magnets and/or coils are polarized oppositely, and at least two magnetic field sensors, wherein, in each case, a magnetic field sensor is arranged between two adjoining rod magnet or coils of the magnet arrangement, especially, in each case, in a region, in which a field strength of the magnetic field is minimum. A first magnetic field is produced between a first and second magnet, or a first and second coil, and a second magnetic field is produced between the second and a third magnet, or the second and a third coil. This arrangement is especially advantageous to perform a differential registering of the process variable and/or characteristic variable of the medium.

Alternatively, the magnet arrangement can for implementing a differential registering of the process variable and/or characteristic variable of the medium also comprise at least two adjoining permanent magnets in the form of ring magnets or ring coils.

The sensor arrangement can comprise, furthermore, at least one shielding element, which surrounds, at least partially, at least the magnet arrangement, so as to shield the magnet arrangement from an environment of the arrangement outside of the containment.

Advantageously, not only a process variable and/or characteristic variable of the medium can be ascertained by means of the sensor unit of the invention. Rather, also a process monitoring can occur based on the magnetic field, or a variable related with the magnetic field.

In an embodiment of the sensor arrangement of the invention, the sensor arrangement, especially the electronics, is embodied to ascertain, based on the magnetic field, a permeability of the medium. The process monitoring and/or the process variable-, or characteristic value ascertainment can then advantageously be performed based on the permeability of the medium.

In an additional advantageous embodiment, the sensor arrangement, especially the electronics, is embodied to ascertain, based on the magnetic field, an, especially predeterminable, fill level of medium in the containment. In such case, the sensor arrangement is a fill level-, or limit level sensor.

However, also other process- and/or characteristic variables of the medium are ascertainable with the help of the sensor arrangement of the invention, such as, for example, the temperature, the pressure, the conductivity, or a flow of the medium.

In summary, the sensor arrangement of the invention is advantageously a non-invasive sensor, which enables especially a characterizing of a process medium based on the magnetic permeability in the process. The measuring can advantageously occur through a non- or weakly magnetic barrier, such as, for example, a wall of a containment, especially stainless steel.

The invention will now be explained in greater detail based on the appended drawing, the figures of which show as follows:

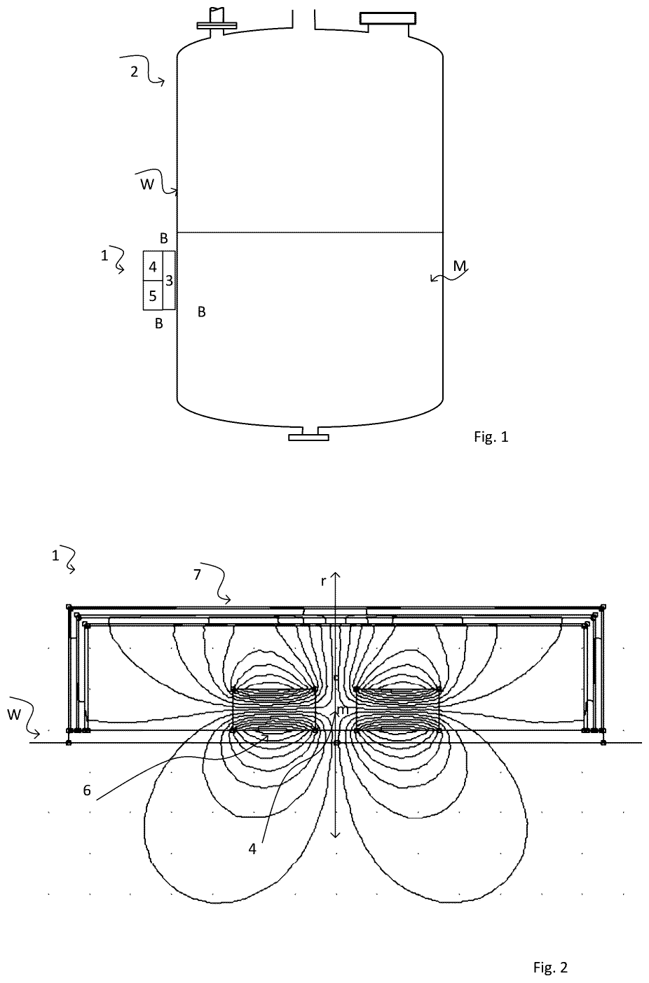

FIG. 1 a schematic drawing of a sensor arrangement of the invention;

FIG. 2 a preferred embodiment of a sensor arrangement of the invention having a magnet arrangement comprising a ring magnet;

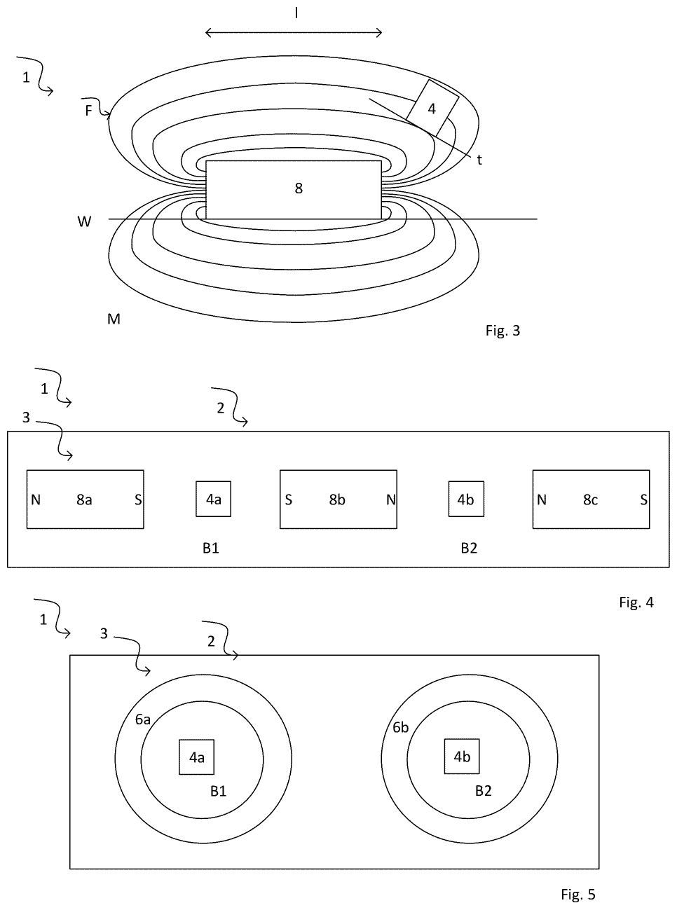

FIG. 3 a preferred embodiment of a sensor arrangement of the invention having a magnet arrangement comprising a rod magnet;

FIG. 4 a preferred embodiment of a sensor arrangement of the invention having at least two permanent magnets in the form of rod magnets and two magnetic field sensors; and

FIG. 5 a preferred embodiment of a sensor arrangement of the invention having at least two permanent magnets in the form of ring magnets and two magnetic field sensors.

In the figures, equal elements are provided with equal reference characters.

FIG. 1 shows a schematic drawing of a sensor arrangement 1 of the invention. Sensor arrangement 1 is arranged externally at the containment 2 filled partially with the medium M and secured to the wall W of the containment 2. The securement can be either a releasable securement or a non-releasable securement. Sensor arrangement 1 includes a magnet arrangement 3 having at least one permanent magnet or at least one coil for producing a magnetic field B, a magnetic field sensor 4 for registering the magnetic field B and an electronics 5 for ascertaining at least one process variable and/or characteristic variable of the medium M.

The magnetic field B penetrates partially through the medium M and is influenced by the properties of the medium M. Correspondingly, based on the magnetic field B registered by the magnetic field sensor 4 or a variable related with the magnetic field B, the process variable and/or characteristic variable of the medium M can be ascertained.

Although all the following embodiments of magnet arrangements 3 are implementable with permanent magnets and coils, the description here is exclusively for permanent magnets. The various considerations hold mutatis mutandis for the case, in which coils are used instead of permanent magnets.

A first preferred example of an embodiment of a sensor arrangement 1 of the invention is shown in FIG. 2. Shown is a sectional view of a sensor arrangement 1, in the case of which the magnet arrangement 3 comprises a permanent magnet in the form of a ring magnet 6. A rotation axis r of the magnet 6 is oriented perpendicularly to the wall W of the containment 2. The ring magnet 6 is, additionally, radially polarized, i.e. in parallel with the wall W of the containment 2. In a region surrounding the midpoint m of the ring magnet 6, the magnetic field strength is minimum. The magnetic field sensor 4 is arranged in this predeterminable region.

Depending on the presence of, and/or the properties of, the medium M located in the container 2 on the side of the wall W opposite the sensor arrangement 1, there results a shifting of the magnetic field lines, and/or a change of the magnetic field B, which is/are registered by the magnetic field sensor 4. By positioning the magnetic field sensor in the predeterminable region of minimum field strength, a saturation of the magnetic field sensor can be avoided. This acts positively on the achievable accuracy of measurement of the sensor arrangement 1.

For the embodiment shown in FIG. 2, the sensor arrangement 1 comprises, furthermore, an optional shielding element 7, which shields the sensor arrangement 1 from an environment of the arrangement 1 outside of the containment 2.

Another preferred embodiment of a sensor arrangement 1 of the invention is shown in FIG. 3. In such case, the magnet arrangement 3 comprises a permanent magnet in the form of a rod magnet 8, whose longitudinal axis I is oriented in parallel with the wall of the container 2. In this way, there results a polarization in parallel with the wall W of the container 2. In contrast with the embodiment of FIG. 2, the magnetic field sensor 4 is, supplementally, oriented perpendicularly to a tangent t of a field line F of the magnetic field B. Also, by this manner of positioning the magnetic field sensor 4 relative to the magnetic field B, an exact and precise registering of the magnetic field B can occur.

For a sensor arrangement 1 of the invention, however, also magnet arrangements 3 with more than one permanent magnet and/or a plurality of magnetic field sensors 4 can be used. Two such preferred embodiments for a sensor arrangement 1 will now be described based on FIGS. 4 and 5.

FIG. 4 shows a plan view of a sensor arrangement 1 having a magnet arrangement 3 comprising three adjoining rod magnets 8a-8c, in the case of which, in each case, a longitudinal axis I extends in parallel with the wall W of the containment 2, similarly to the case of the embodiment shown in FIG. 3. Thus, there results from the first 8a and second magnets 8b a first magnetic field B1 and from the second 8b and third magnets 8c a second magnetic field B2.

In each case, magnetic field sensors 4a, or 4b are arranged between the two adjoining rod magnets 8a and 8b, and 8b and 8c, respectively. The magnet 8a-8c are, in each case, oppositely polarized. In this way, there results, similarly to the case of the embodiment shown in FIG. 2, in each case, between two adjoining magnet 8a and 8b, and 8b and 8c, a predeterminable region of minimum field strength centrally between the two magnets 8a and 8b, and 8b and 8c. Arranged In these two regions, respectively, are the magnetic field sensors 4a and 4b. Based on the first B1 and second magnetic fields B2, then, advantageously, a differential determining of the particular process- and/or characteristic variable of the medium can occur.

A similar arrangement 1 is shown in FIG. 5. In such case, the magnet arrangement 3 comprises two ring magnets 6a and 6b, which are arranged next to one another on the container wall W and oriented in parallel with such, similarly to the case of the embodiment shown in FIG. 2. The two ring magnets 6a and 6b are oppositely polarized, wherein, in each case, a magnetic field sensor 4a, 4b is arranged centrally in each of the two ring magnets 6a, 6b. Also in such case, the two magnetic fields B1 and B2 are registered by means of the two magnetic field sensors 4a, 4b, such that a differential determining of the particular process- and/or characteristic variable of the medium is possible.

### LIST OF REFERENCE CHARACTERS

1 sensor arrangement
2 containment
3 magnet arrangement
4 4a, 4b magnetic field sensors
5 electronics
6 6a, 6b permanent magnets in the form of ring magnets
7 shielding element
8 8a-8c permanent magnets in the form of rod magnets
M medium
B B1, B2 magnetic fields
W wall of the containment
r rotation axis
m midpoint
l longitudinal axis
t tangent
F field line
N north pole
S south pole

1-15. (canceled)

16. A sensor arrangement for determining and/or monitoring at least one process variable and/or characteristic variable of a medium in a containment, comprising:
a magnet arrangement including at least one permanent magnet and/or at least one coil for producing a magnetic field, wherein the magnet arrangement is arranged and/or embodied such that the magnetic field penetrates, at least partially, through the medium in the containment and is influenced by at least one property of the medium;
at least one magnetic field sensor for detecting the magnetic field; and
an electronics for determining and/or monitoring the at least one process variable and/or characteristic variable based on the magnetic field,
wherein the magnet arrangement and the at least one magnetic field sensor are arranged outside of the containment and secured on a wall of the containment.

17. The sensor arrangement as claimed in claim 16,
wherein the magnet arrangement is arranged and/or embodied such that in a predeterminable region a field strength of the magnetic field is minimum.

18. The sensor arrangement as claimed in claim 16,
wherein the magnet arrangement includes the at least one permanent magnet and the at least one permanent magnet of the magnet arrangement is magnetized in parallel with the wall of the containment.

19. The sensor arrangement as claimed in claim 18,
wherein the at least one permanent magnet is a ring magnet or a rod magnet.

20. The sensor arrangement as claimed in claim 16,
wherein the magnet arrangement includes at least two permanent magnets and/or at least two coils for producing at least two magnetic fields, wherein the magnet arrangement is arranged and/or embodied such that the at least two magnetic fields penetrate, at least partially, through the medium in the containment and are influenced by at least one property of the medium.

21. The sensor arrangement as claimed in claim 20,
wherein the at least two permanent magnets and/or the at least two coils are arranged adjoining one another.

22. The sensor arrangement as claimed in claim 21,
wherein the at least two permanent magnets and/or the at least two coils are arranged and/or embodied such that they are oppositely polarized.

23. The sensor arrangement as claimed in claim 22,
comprising at least two magnetic field sensors, wherein each magnetic field sensor is arranged such that it can register one of the at least two magnetic fields, and wherein the electronics is embodied to ascertain the at least one process variable and/or characteristic variable of the medium based on the at least two magnetic fields.

24. The sensor arrangement as claimed in claim 16,
wherein the magnetic field sensor is a flux gate sensor, a magnetostrictive sensor, a sensor comprising a mechanically oscillatable, magnetoelectric sensor element, or a quantum sensor.

25. The sensor arrangement as claimed in claim 16,
wherein the magnetic field sensor is arranged in a predeterminable region outside of the containment where a field strength of the magnetic field is minimum.

26. The sensor arrangement as claimed in claim 16,
wherein the magnetic field sensor is arranged such that it is oriented perpendicularly to a tangent of a field line of the magnetic field.

27. The sensor arrangement as claimed in claim 16,
wherein the at least one permanent magnet is a ring magnet or the at least one coil is a ring coil,
wherein the at least one permanent magnet or the at least one coil is secured on the wall of the containment such that a rotation axis of the ring magnet or the ring coil is oriented perpendicularly to the wall of the containment, and
wherein the magnetic field sensor is arranged in a region around a midpoint of the ring magnet or the ring coil.

28. The sensor arrangement as claimed in claim 16,
wherein the magnet arrangement includes at least three adjoining permanent magnets in the form of rod magnets or at least three adjoining coils wherein the rod magnets or the coils are magnetized and arranged, in each case, in parallel with wall of the containment, and wherein, the adjoining rod magnets and/or the coils are polarized oppositely, and at least two magnetic field sensors, wherein, in each case, a magnetic field sensor is arranged between two adjoining rod magnets or coils of the magnet arrangement, in each case, in a region in which a field strength of the magnetic field is minimum.

29. The sensor arrangement as claimed in claim 16,
wherein the sensor arrangement is embodied to ascertain, based on the magnetic field, a permeability of the medium.

30. The sensor arrangement as claimed in claim 16,
wherein the sensor arrangement is embodied to ascertain, based on the magnetic field, a predeterminable fill level of medium in the containment.
